(19) United States
(12) Patent Application Publication
(10) Pub. No.: US 2023/0309157 A1
(43) Pub. Date: Sep. 28, 2023

(54) INTERNET-OF-THINGS SYSTEM AND CONNECTION SETTING METHOD THEREOF

(71) Applicants: C&L Consulting Inc., Taipei (TW); Columbia AIoT Technologies Co., LTD., New Taipei (TW)

(72) Inventors: Fu-Chiung Cheng, New Taipei (TW); Wei-Cheng Liu, Taipei (TW); Dai-Xin Wang, Taipei (TW)

(21) Appl. No.: 18/111,333

(22) Filed: Feb. 17, 2023

(30) Foreign Application Priority Data
Mar. 24, 2022 (TW) 111111194

(51) Int. Cl. H04W 76/10; H04W 12/122

(52) U.S. Cl. CPC H04W 76/10; H04W 12/122; H04W 88/16

(57) ABSTRACT

An Internet of Things (IoT) system includes an application server, an identification information server, a gateway, and a terminal electronic device. The identification information server is configured to generate a plurality of pieces of first identification information, and each piece of first identification information is time-sensitive. The gateway is connected to the application server and stores the pieces of first identification information. The gateway is configured to automatically determine a piece of valid identification information from the pieces of first identification information. The terminal electronic device stores the pieces of first identification information and is configured to automatically and successively select a piece of current identification information from the pieces of first identification information to establish a connection with the gateway. When the current identification information is consistent with the valid identification information, the gateway establishes the connection with the terminal electronic device.

### CROSS-REFERENCE TO RELATED APPLICATIONS

This application claims priority to Taiwan Patent Application No. 111111194 filed on Mar. 24, 2022, which is hereby incorporated by reference in its entirety.

### BACKGROUND OF THE INVENTION

The present disclosure relates to an Internet of Things (IoT) system and a connection setting method thereof. More specifically, the present disclosure relates to an IoT system with an automatic and secure connection and a connection setting method thereof.

According to the Bluetooth specification, Bluetooth apparatuses include central apparatuses and peripheral apparatuses. A peripheral apparatus may send out an advertising packet, and a nearby central apparatus may transmit a request for connection to the peripheral apparatus after receiving the advertising packet of the peripheral apparatus. If the peripheral apparatus agrees with the request for connection, then the peripheral apparatus establishes a Bluetooth connection with the central apparatus. For the sake of security, the existing Bluetooth specification provides several methods for verifying whether a peripheral apparatus has established a Bluetooth connection with the right central apparatus, and vice versa (i.e., Bluetooth pairing), such as Numeric Comparison, Passkey Entry, and Out-of-Band (OOB). In the method of Numerical Comparison, a set of numbers is displayed on both of the peripheral apparatus and the central apparatus, and the user needs to confirm whether the sets of numbers are consistent for the verification. In the method of Passkey Entry, a set of numbers is displayed on one of the peripheral apparatus and the central apparatus, and the user needs to correctly input the set of numbers into another apparatus for the verification. OOB means other methods, and a common practice is to move the peripheral apparatus and the central apparatus within a distance close enough for the user to do the verification through Near Field Communication (NFC). However, the existing methods of verification usually require the intervention of users, rather than being automatic, and thus they are not suitable for being implemented in the field of Internet of Things (IoT) that involves a large number of apparatuses.

In view of the situation above, there is an urgent need in the art to provide an automatic and safe Bluetooth connection method.

### SUMMARY OF THE INVENTION

To solve at least the abovementioned problem, the present disclosure provides an IoT system. The IoT system comprises an identification information server, an application server, a gateway connected with the identification information server and the application server, and a terminal electronic device. The identification information server may be configured to generate a plurality of pieces of first identification information, wherein each piece of first identification information has an expiration period. The gateway may store the plurality of pieces of first identification information, and may be configured to automatically determine a piece of valid identification information from the plurality of pieces of first identification information. The terminal electronic device may store the plurality of pieces of first identification information, and may be configured to automatically and successively select a piece of current identification information from the plurality of pieces of first identification information to establish a connection with the gateway. When the piece of current identification information is consistent with the piece of valid identification information, the gateway may establish the connection with the terminal electronic device.

To solve at least the abovementioned problem, the present disclosure also provides a connection setting method for an IoT system. The connection setting method may comprise steps as follows:
generating, by an identification information server, a plurality of pieces of first identification information, each piece of first identification information having an expiration period;
determining automatically, by a gateway, a valid identification information from the plurality of pieces of first identification information; and
automatically and successively selecting, by a terminal electronic device, a piece of current identification information from the plurality of pieces of first identification information to establish a connection with the gateway, wherein the gateway establishes the connection with the terminal electronic device when the piece of current identification information is consistent with the piece of valid identification information.

As described above, since both the terminal electronic device and the gateway of the present disclosure store the plurality of pieces of identification information for connection setting, the terminal electronic device may be configured to automatically and successively attempt connecting to the gateway via the plurality of pieces of identification information after startup, and the user of the terminal electronic device is not required to manually configure the connection, thereby improving the connection efficiency (i.e., an automatic connection is implemented). In addition, each piece of identification information used in the connection between the terminal electronic device and the gateway of the present disclosure is time-sensitive, so the problem of easy cracking due to the use of the same identification information for a long period of time for connection can be avoided. Therefore, the connection security between the terminal electronic device and the gateway can be enhanced.

This summary overall describes the core concept of the present invention and covers the problem to be solved, the means to solve the problem and the effect of the present invention to provide a basic understanding of the present invention by those of ordinary skill in the art. However, it shall be appreciated that, this summary is not intended to encompass all embodiments of the present invention but is provided only to present the core concept of the present invention in a simple form and as an introduction to the following detailed description. The detailed technology and preferred embodiments implemented for the subject invention are described in the following paragraphs accompanying the appended drawings for people having ordinary skills in the art to well appreciate the features of the claimed invention.

### BRIEF DESCRIPTION OF DRAWINGS

FIG. 1 depicts a schematic view of an IoT system according to one or more embodiments of the present disclosure;

FIGS. 2A-2G depict schematic views of the connection setting of the IoT system according to one or more embodiments of the present disclosure;

FIGS. 3A-3B depict schematic views of the operations of the IoT system according to one or more embodiments of the present disclosure;

FIG. 4 depicts a schematic view of the IoT system handling connection errors for the terminal electronic device according to one or more embodiments of the present disclosure;

FIG. 5 depicts a schematic view of the IoT system handling connection errors for the gateway according to one or more embodiments of the present disclosure;

FIG. 6 depicts a schematic view of the terminal electronic device being installed in the wired connection manners in the IoT system according to one or more embodiments of the present disclosure;

FIG. 7 depicts a schematic view of two devices of the IoT system performing transactions using the identification information as a token according to one or more embodiments of the present disclosure; and

FIG. 8 depicts a connection setting method according to one or more embodiments of the present disclosure.

### DETAILED DESCRIPTION OF THE INVENTION

The embodiments described in the following description are not intended to limit the present invention to any environment, applications, or implementations described in these embodiments. It should be appreciated that, in the following embodiments and the attached drawings, elements unrelated to the present invention are omitted from depiction. In addition, dimensions of and dimensional scales among individual elements in the attached drawings are provided only for illustration, but not to limit the scope of the present invention. Moreover, the same (or similar) reference numerals may correspond to the same (or similar) elements. In the following description, unless otherwise specified.

The terms used herein are for the purpose of describing the embodiments only and are not intended to limit the invention. The singular form “a” is intended to include the plural form as well, unless the context clearly dictates otherwise. The terms “comprise”, “include” and the like designate the existence of the roles, integers, steps, operations and/or elements, but do not exclude the existence or addition of one or more other roles, integers, steps, operations, elements and/or combinations thereof. The term “and/or” includes any and all combinations of one or more of the associated listed items. Although the terms “first”, “second”, “third”, etc. may be used herein to describe various elements, these elements should not be limited by these terms. These terms are only used to distinguish one element from another. Thus, for example, a first element described below could also be referred to as a second element without departing from the spirit and scope of the present invention.

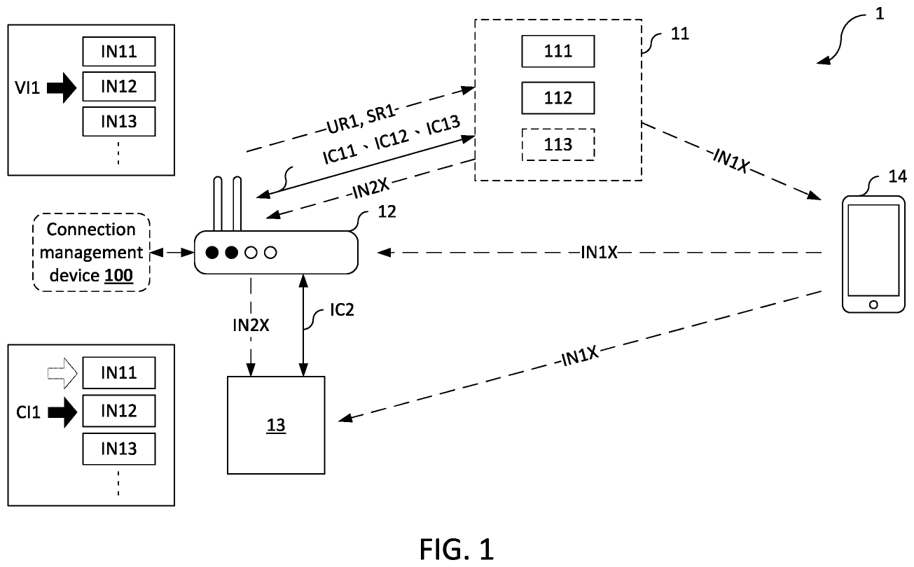

FIG. 1 depicts a schematic view of an IoT system according to one or more embodiments of the present disclosure. The contents shown in FIG. 1 are only for easily illustrating the embodiments, instead of limiting the scope of the present disclosure. Referring to FIG. 1, an IoT system 1 may comprise a device management server (DMS) 111, an identification information server 112, an application server 113, a gateway 12 and a terminal electronic device 13.

The device management server 111 may be configured to manage various devices in the IoT system and maintain relevant information of each device. The identification information server 112 may be configured to generate and manage identification information required for connection between various devices in the IoT system. The application server 113 may be configured to manage application data generated, received, and/or used by various devices in the IoT system when operating and providing services (e.g., IoT-enabled medical equipment). Each server may have a stable connection with others so as to communicate with each other.

In some embodiments, the device management server 111, the identification information server 112, and the application server 113 may be integrated into a single server 11 as a device management module, an identification information management module, and an application information module therein, respectively, and still perform their original functions respective. There may be a wired or wireless connection IC11 between the device management server 111 and the gateway 12. There may be a wired or wireless connection IC12 between the identification information server 112 and the gateway 12. There may be a wired or wireless connection IC13 between the application server 113 and the gateway 12.

The gateway 12 may be a computing device with the information transfer and/or protocol conversion functions of common network gateways. In the IoT system 1, there may be a plurality of gateways 12, and each gateway 12 may process the IoT information flow of a plurality of terminal electronic devices 13 in different locations.

The terminal electronic device 13 may be various smart home appliances, and may also be network-connected precision instruments, medical instruments, or other electronic devices. The terminal electronic device 13 may be connected with the gateway 12 and thus indirectly connected to the server 11 through the gateway 12, thereby achieving the effect of IoT.

In some embodiments, the IoT system 1 may further comprise a computing device 14, which may be a device with computing capabilities, such as but not limited to a portable communication device, a computer, a wearable smart device, etc. The computing device 14 and the server 11 are connected with each other through a secure connection mechanism. The computing device 14 may be provided with a connection setting application for assisting the connection setting of the terminal electronic device 13 and/or the gateway 12.

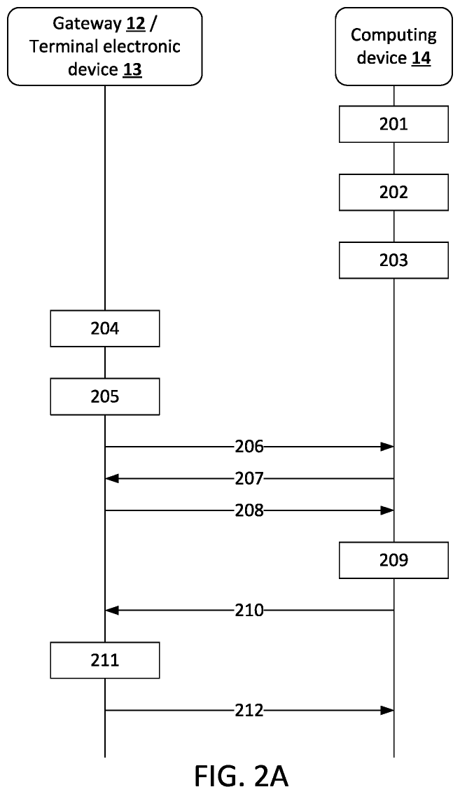

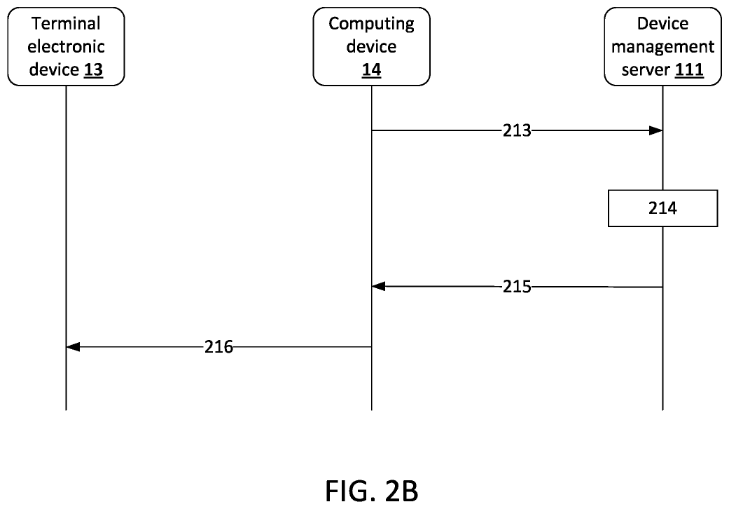

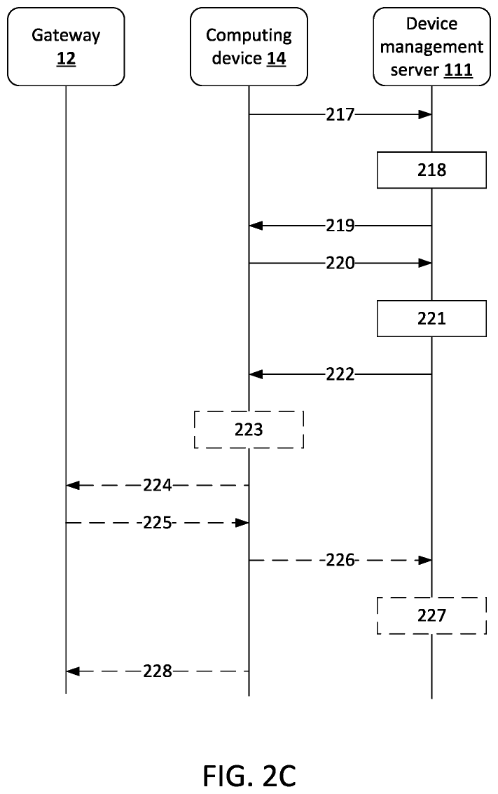

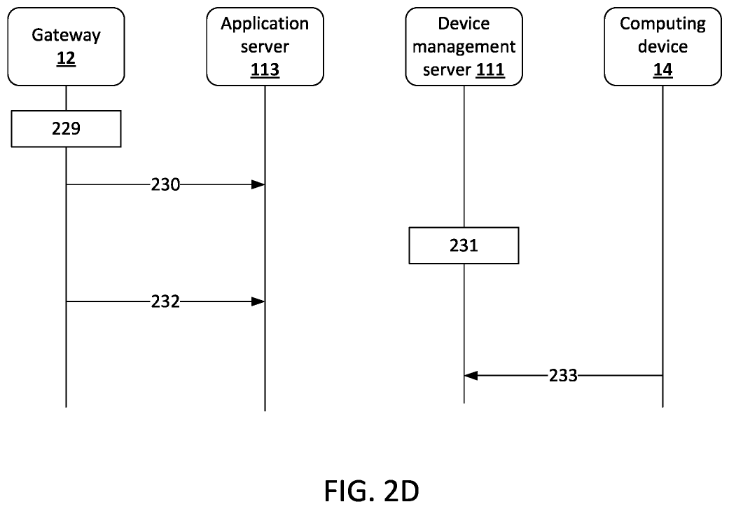

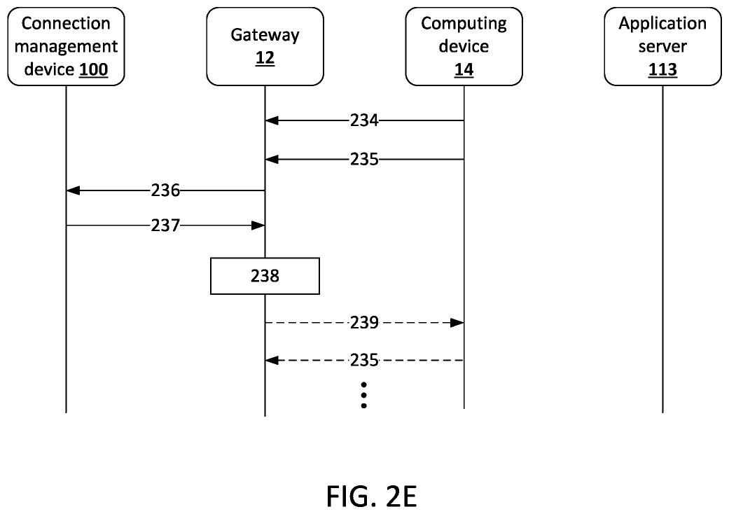

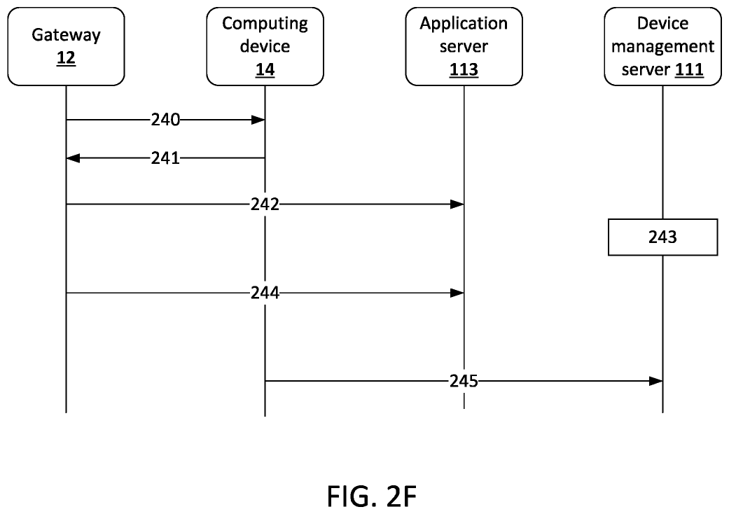

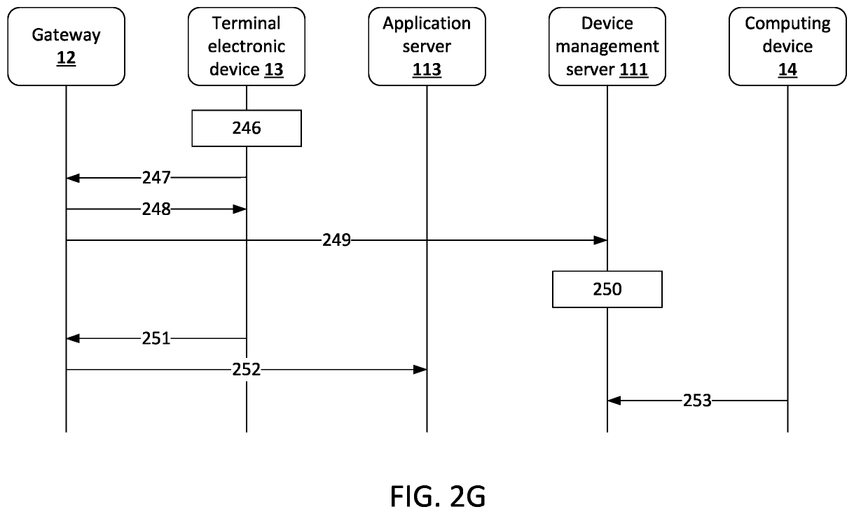

FIGS. 2A-2G depict schematic views of the connection setting of the IoT system according to one or more embodiments of the present disclosure. The contents shown in FIGS. 2A-2G are only for easily illustrating the embodiments, instead of limiting the scope of the present disclosure. Please refer to FIG. 2A first. The initialization setting of connection of the gateway 12 and/or the terminal electronic device 13 in the IoT system 1 may start from the setting of the identification information. When the gateway 12 or the terminal electronic device 13 is to perform the initialization setting of connection in the IoT system 1, the computing device 14 may activate the access point (AP) mode (i.e., action 201) based on a preset piece of identification information (e.g., an identifier (SSID) and a corresponding password for setting up the wireless network connection), and wait for the access of the other device (i.e., action 202).

In addition, the computing device 14 may obtain an identification information set IN1X that comprises a plurality of pieces of identification information IN11, IN12, IN13, etc. from the identification information server 112 (i.e., action 203). Specifically, the identification information server 112 may be configured to generate the identification information set IN1X. In some embodiments, the identification information server 112 may generate the identification information set IN1X by a hashing process, so that each piece of identification information is represented by a hash value. It should be noted that the action 203 may be executed following the completion of the action 201 or the action 202, or may be executed following the completion of the action 209 (i.e., determining the validity of the accessing device). Furthermore, in some other embodiments, the action 203 may be replaced with that the computing device 14 generates the identification information set IN1X by itself.

Each piece of identification information in the set of identification information IN1X may be a set of account ID and passwords, a set of public and private keys, a set of secret keys, or one or more pieces of data that may be used to allow one party to identify the legitimacy of the other party. In addition, each piece of identification information in the identification information set IN1X may have an expiration period, that is, each piece of identification information may have a valid state and an invalid state. The expiration period may be in seconds, minutes, hours, days, weeks, months, quarters, or years. The lengths of the expiration period of the identification information in the identification information set IN1X may be exactly the same, partially the same, or completely different. For example, on the first day, the first piece of identification information IN11 is valid, while the second piece of identification information IN12 and the third piece of identification information IN13 are invalid; on the second day, the first piece of identification information IN11 becomes invalid, the second piece of identification information IN12 becomes valid, and the third piece of identification information IN13 is still invalid; and on the third day, the first piece of identification information IN11 is still invalid, the second piece of identification information IN12 becomes invalid, and the third piece of identification information IN13 becomes valid. For another example, in the first week, the three pieces of identification information IN11, IN12, and IN13 are all valid; in the second week, the three pieces of identification information IN11, IN12, and IN13 all become invalid; and in the third week, the three pieces of identification information IN11, IN12, and IN13 all become valid again. For another example, on the first day, the first piece of identification information IN11 is valid, while the second piece of identification information IN12 and the third piece of identification information IN13 are invalid; from the second to the fourth day, the first piece of identification information IN11 becomes invalid, the second piece of identification information IN12 becomes valid, and the third piece of identification information IN13 remains invalid; and from the fourth to the fifth day, the first piece of identification information IN11 remains invalid, the second piece of identification information IN12 becomes invalid, and the third piece of identification information IN13 becomes valid.

In some embodiments, the identification information server 112 or the computing device 14 may create a configuration file, and define, in the configuration file, the expiration period of each identification information in the identification information set IN1X. The target equipment (e.g., the gateway 12 or the terminal electronic device 13) may check when the identification information needs to be changed after the configuration file is installed and/or executed.

When the gateway 12 or the terminal electronic device 13 is activated (i.e., action 204, e.g., when the power is turned on), it may detect the computing device 14 in the AP mode by scanning the connection (i.e., action 205), and use the same default identification information as in the computing device 14 to connect to the computing device 14 (i.e., action 206). If the connection is successfully established, the computing device 14 may report the connection success to the gateway 12 or the terminal electronic device 13 that needs the connection setting (i.e., action 207).

Next, the gateway 12 and/or the terminal electronic device 13 that needs the connection setting may transmit an authentication code (i.e., action 208) to the computing device 14 for confirmation. After the computing device 14 confirms that the authentication code is correct (i.e., action 209), the computing device 14 may transmit the identification information set IN1X to the gateway 12 and/or the terminal electronic device 13 (i.e., action 210) such that the gateway 12 and/or the terminal electronic device 13 stores the identification information set IN1X. After obtaining the identification information set IN1X, the gateway 12 and/or the terminal electronic device 13 may perform the setting according to the identification information (i.e., action 211), and report back to the computing device 14 after completion (i.e., action 212).

In some other embodiments, the identification information set IN1X may be stored in the gateway 12 and the terminal electronic device 13 during the production phase of the gateway 12 and the terminal electronic device 13 (e.g., as a default setting). In some other embodiments, the identification information set IN1X may be stored in the gateway 12 and the terminal electronic device 13 after the gateway 12 and the terminal electronic device 13 enter the market.

Please refer to FIG. 2B. The process of device registration may be performed after completing the setting of the identification information. Specifically, if the device to be registered is the terminal electronic device 13, the computing device 14 may report to the device management server 111, after completing the action 212, to register the terminal electronic device 13 (i.e., action 213). Correspondingly, after receiving the report, the device management server 111 may start to maintain the information of the terminal electronic device 13 and set the status of the terminal electronic device 13 to “registered but not connected to the application server” (i.e., action 214). Subsequently, the device management server 111 may reply that the computing device 14 has completed the device registration (i.e., action 215), and accordingly, the computing device 14 may notify the terminal electronic device 13 that the connection setting has been completed (i.e., action 216).

Next, refer to FIG. 2C. On the other hand, if the device to be registered is the gateway 12, after completing the action 212, the computing device 14 may report to the device management server 111 to register the new gateway 12 (i.e., action 217). Accordingly, after receiving the report, the device management server 111 may start to maintain the information of the gateway 12 and set the status of the gateway 12 to “registered but not connected to the application server” (i.e., action 218). Subsequently, the device management server 111 may reply that the computing device 14 has completed the device registration (i.e., action 219).

If the computing device 14 has the knowledge about the location of workplace (e.g., a specific hospital, store, etc.) at which the gateway 12 is to be set up, it may notify the device management server 111 of the location (i.e., action 220). Accordingly, the device management server 111 may record the location of workplace (i.e., action 221) and report that the computing device 14 has completed the setting (i.e., action 222).

Additional actions 223-227 may be performed if the connection setting information in the workplace of the gateway 12 is known at this registration phase. More specifically, the computing device 14 may first obtain (e.g., via the input of the user in the connection setting application) the connection setting information of the gateway 12 in its workplace (i.e., action 223), and provide the connection setting information to the gateway 12 (i.e., action 224). For example, a fixed IP address may be set first if the gateway 12 needs to use a wired network connection to communicate with the application server 113 in the workplace. On the contrary, if a wireless network connection is used, the corresponding SSID and password may be set.

Subsequently, the gateway 12 may report the completion of connection setting to the computing device 14 after receiving the connection setting information corresponding to the workplace (i.e., action 225), and the computing device 14 may report the connection configuration of the gateway 12 to the device management server 111 (i.e., action 226), such that the device management server 111 may record the connection configuration of the gateway 12 (i.e., action 227). Finally, computing device 14 may notify the gateway 12 that its connection setting is complete (i.e., action 228). In some embodiments, when the device management server 111 and the application server 113 are two independent servers, the device management server 111 may share its recorded connection configuration about the gateway 12 with the application server 113 through a network connection, such that the gateway 12 may successfully connect to the application server 113 in the workplace.

During the above-mentioned phases of identification-information setting and device registration, the gateway 12 may not necessarily be in its workplace (i.e., the location where it actually works to complete the setting), but may be in other locations (e.g., the factory where the gateway 12 is produced). When the gateway 12 is in its workplace and is about to be installed, the gateway 12 may be directly connected to the server (e.g., the application server 113) according to its connection configurations after normal startup.

Refer to FIG. 2D. For example, when the user wants to install the gateway 12 in the workplace, the gateway 12 may, first, be activated (i.e., action 229). If the gateway 12 has completed the network configuration during the device registration phase, it will now be able to connect directly to the application server 113 (i.e., action 230). Accordingly, the device management server 111 may change the state of the gateway 12 to “connected to the application server 113” (i.e., action 231, this information may be learned via its communication with the application server 113 or with the computing device 14), and gateway 12 may begin transmitting its data to the application server 113 (i.e., action 232). The user or device administrator may query the device management server 111 for the operating status of the gateway 12 through the computing device 14 (i.e., action 233).

Refer to FIG. 2E. On the contrary, when the connection setting information required by the gateway 12 in its workplace cannot be known during the above-mentioned registration phase, the network connection between gateway 12 and the application server 113 cannot be set up until the installation of the gateway 12 in the workplace. Specifically, at the beginning installing the gateway 12 in the workplace, the computing device 14 may first connect to the gateway 12 (i.e., action 234), and then perform the connection setting of the gateway 12 (i.e., action 235). A fixed IP address may be set first if the gateway 12 needs to communicate with the application server 113 in the workplace via wired network connection. On the contrary, a corresponding set of SSID and password may be set if the gateway 12 needs to communicate with the application server 113 in the workplace via a wireless network connection.

Next, the gateway 12 may request an IP address (i.e., action 236) from a connection management device 100 as shown in FIG. 1 (e.g., an access point (AP) device or a wired-network management device), and the connection management device 100 may assign an IP address to the gateway 12 accordingly and allow it to connect to the network of the workplace (i.e., action 237).

The gateway 12 may then check whether the network of the workplace can be successfully connected (i.e., action 238). In some embodiments, the gateway 12 may report to the computing device 14 when it finds out that the network of the workplace is abnormal (i.e., action 239). After receiving the report, the computing device 14 may perform the action 235 again until the abnormal network condition is eliminated.

Refer to FIG. 2F. When the gateway 12 determines that the network of the workplace can be properly connected, it may report to the computing device 14 that the network is normal (i.e., action 240), and the computing device 14 may accordingly respond to the gateway 12 that its connection setting has been completed (i.e., action 241). Then, similar to actions 230-233, gateway 12 may connect to the application server 113 (i.e., action 242). Accordingly, the device management server 111 may change the state of the gateway 12 to “connected to the application server 113” (i.e., action 243), and the gateway 12 may start transmitting its data to the application server 113 (i.e., action 244). The user or device administrator may query the device management server 111 for the operating status of the gateway 12 through the computing device 14 (i.e., action 245).

Refer to FIG. 2G. The user may activate the terminal electronic device 13 first when he/she wants to install the terminal electronic device 13 in the same workplace (i.e., action 246). The terminal electronic device 13 may automatically attempt to connect to the gateway 12 using one of the identification information in the identification information set IN1X stored therein (i.e., action 247), and the gateway 12 may accordingly reply to the terminal electronic device 13 that the connection has been successfully established (i.e., action 248). Next, the gateway 12 may notify the device management server 111 that a new device has joined the network of the workplace (i.e., action 249), and the device management server 111 may change the status of the terminal electronic device 13 to “connected” (i.e., action 250).

After being successfully connected with the gateway 12, the terminal electronic device may begin its data transmission to the gateway 12 (i.e., action 251), and the gateway 12 may further forward the data transmitted by the terminal electronic device 13 to the application server 113 (i.e., action 252). Finally, similar to the actions 233 and 245, the user or the device administrator may query the device management server 111 for the operation status of the terminal electronic device 13 through the computing device 14 (i.e., action 253).

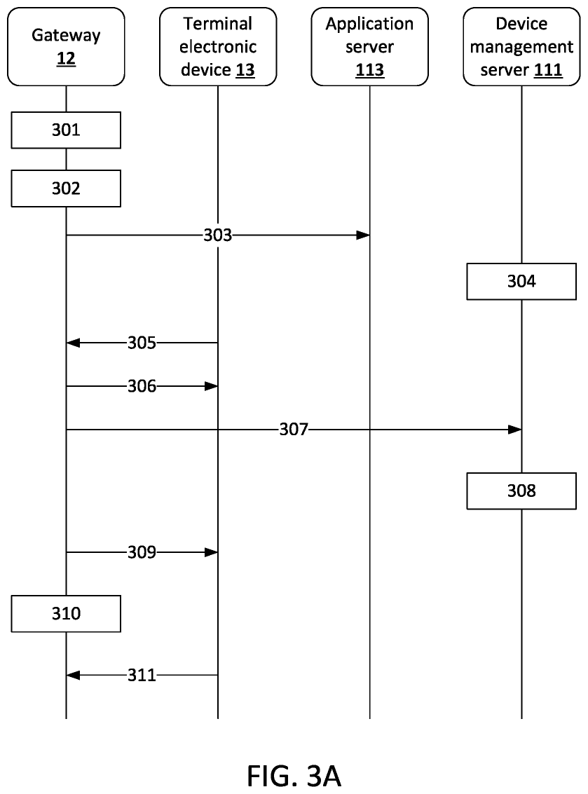

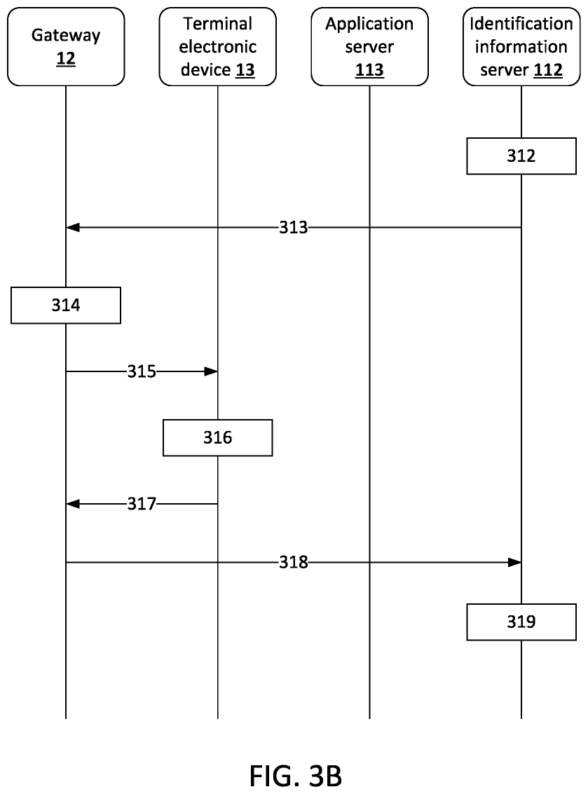

FIGS. 3A-3B depict schematic views of the operations of the IoT system according to one or more embodiments of the present disclosure. The contents shown in FIGS. 3A-3B are only for easily illustrating the embodiments, instead of limiting the scope of the present disclosure. Please refer to FIGS. 3A-3B together. After completing the connection setting and on-site installation of the gateway 12 and the terminal electronic device 13, first, in action 301, the gateway 12 may determine a piece of valid identification information VI1 from the stored identification information set IN1X after being activated (i.e., selecting a certain piece of identification information in a valid state), and enable the access point mode according to the valid identification information VI1 (i.e., action 302). Gateway 12 may also be connected to the application server 113 (i.e., action 303), and device management server 111 may change the state of gateway 12 to “connected to application server” (i.e., action 304).

On the other hand, the terminal electronic device 13 may automatically and successively select a piece of identification information from the stored identification information set IN1X as current identification information CI1 after being activated, and attempt to establish a connection IC2 with the gateway 12 according to the current identification information CI1 (i.e., action 305). The connection to IC2 may be successfully established when the current identification information CI1 selected by the terminal electronic device 13 is consistent with the valid identification information VI1 determined by the gateway 12 (e.g., the valid identification information VI1 and the current identification information CI1 are both the identification information IN12).

When the current identification information CI1 does not match the valid identification information VI1 (e.g., the valid identification information VI1 is the identification information IN12, but the current identification information CI1 is the identification information IN11), the terminal electronic device 13 may automatically select another piece of identification information (e.g., identification information IN12, or identification information IN13) from the identification information set IN1X as the current identification information CI1, until the connection IC2 with the gateway 12 is successfully established. Through this mechanism, the terminal electronic device 13 may be automatically connected to the gateway 12 when it is activated, without the need for manual settings by the user, thereby achieving a real-time network connection setting between the terminal electronic device 13 and the gateway 12 and thus improving the connection efficiency.

Since each identification information in the identification information set IN1X is time-sensitive, in some embodiments, the terminal electronic device 13 may be configured to select the current identification information C1 only from the identification information in a valid state, so as to reduce the number of attempts.

When the terminal electronic device 13 successfully establishes the connection IC2 with the gateway 12, the gateway 12 may reply that the terminal electronic device 13 has been successfully connected (i.e., action 306), and may notify the device management server 111 via the connection IC11 that the terminal electronic device 13 is connected (i.e., action 307). The device management server 111 may change the status of the terminal electronic device 13 to “connected” (i.e., action 308).

In some embodiments, each piece of identification information in the identification information set IN1X may be an SSID and a corresponding password for setting a wireless network connection. In other words, the gateway 12 may set the connection according to the SSID and the corresponding password, and the terminal electronic device 13 selects a set of SSID and password from the identification information set IN1X for attempting to establish the connection IC2 with the gateway 12. The format of the SSID and password may be English letters, numbers, symbols and so on. Due to the wide variety of options of character content, there is little chance that a same set of SSID and password are adopted.

When the valid identification information VI1 (e.g., identification information IN12) has expired (i.e., switching from the valid state to the invalid state), the gateway 12 may notify the terminal electronic device 13 that the identification information to use is going to be replaced (i.e., action 309), and then determine another piece of identification information (e.g., identification information IN13) that is in a valid state from the identification information set IN1X as the valid identification information VI1 (i.e., action 310). That is to say, the gateway 12 may determine the valid identification information VI1 according to the expiration period of each piece of identification information in the identification information set IN1X, so as to strengthen the connection security.

Correspondingly, in the terminal electronic device 13, when the current identification information CI1 (e.g., the identification information IN12) has expired or the connection IC2 fails due to the gateway 12 changing the valid identification information VI1, the terminal electronic device 13 may automatically and successively select other identification information (e.g., identification information IN13) from the identification information set IN1X as the current identification information CI1 until the connection IC2 is re-established (i.e., action 311).

In some embodiments, the identification information in the identification information set IN1X may have an order. Moreover, in some embodiments, the identification information may alternately present a valid state according to the order. For example, the identification information in the first place may be in a valid state first, and the remaining identification information may turn into the valid state by turns according to the order, and then turn back to an invalid state after its expiration period has passed. With this mechanism, both the gateway 12 and the terminal electronic device 13 may adopt, in turn and according to the order, each identification information in the valid state in the identification information set IN1X for connection setting.

In some embodiments, each piece of identification information in the identification information set IN1X may not only be an SSID and the corresponding password for setting up a wireless network connection, but the identification information may also have an order. Under such circumstances, each identification information in the identification information set IN1X may be as shown in Table 1 below:

TABLE 1

| | | | Expiration |
|---|---|---|---|
| Order | ID | Password | Period (Day) |
| 1 | ID0134 | ytr367y6 | 3 |
| 2 | ID0528 | 580dn243 | 3 |
| 3 | ID0729 | 0673hd03 | 3 |
| 4 | ID5568 | 0k39g7ba | 3 |

When determining that it is necessary to replace the identification information set (e.g., more than half of the identification information in the current identification information set has been used, or upon receipt of an updating request UR1 from an external device such as the gateway 12), the identification information server 112 may generate identification information set IN2X containing multiple pieces of identification information (i.e., action 312), and transmit the identification information set IN2X to the gateway 12 (i.e., action 313).

In some embodiments, the gateway 12 may periodically transmit the update request UR1 to the identification information server 112, and the period at which the gateway 12 transmits the update request UR1 is less than the sum of expiration periods of the pieces of identification information in the identification information set IN1X, so as to obtain the next batch of identification information before the identification information is used up, thereby avoiding adopting the identification information that has already been used. For instance, as shown in Table 1, the gateway 12 may transmit the update request UR1 to the server 11 every six days (i.e., half of the total expiration period).

In some embodiments, the number of pieces of identification information in the identification information set IN2X may be the same as the number of pieces of identification information that has been used in the identification information set IN1X (e.g., half the number of pieces of identification information in the identification information set IN1X). The gateway 12 may update the pieces of identification information used accordingly after receiving the identification information set IN2X (i.e., action 314). For example, the gateway 12 may only use the identification information set IN2X to replace the used identification information instead of completely replacing the identification information set IN1X when the number of pieces of identification information in the identification information set IN2X is less than the identification information set IN1X.

In addition, since there is a connection IC2 between the gateway 12 and the terminal electronic device 13, the gateway 12 may also transmit the identification information set IN2X or its updated pieces of identification information to the terminal electronic device 13, and notify it to update the identification information therein (i.e., action 315). Then, the terminal electronic device 13 may update the used identification information based on the identification information set IN2X (i.e., action 316). For example, the terminal electronic device 13 may only use the identification information set IN2X to replace the used identification information, or may directly replace the identification information set IN1X therein with the plurality of pieces of identification information updated by the gateway 12. With this mechanism, the identification information for setting the connection IC2 may be continuously and periodically replaced, so as to avoid reusing the same identification information as much as possible.

When the terminal electronic device 13 completes the update of the identification information, it may notify the gateway 12 (i.e., action 317), and the gateway 12 may transmit the updated identification information to the identification information server 112, and notify it to update the identification information therein (i.e., action 318). The identification information server 112 may record the plurality of identification information updated by the gateway 12 (i.e., action 319).

In some embodiments, the gateway 12 may also periodically transmit a status report SRI to the device management server 111 to report the operating status of the gateway 12 and the terminal electronic device 13.

In some embodiments, the gateway 12 may also be used to detect cyberattacks (e.g., distributed denial of service, DDoS) launched by one or more external devices against the gateway 12, and may issue corresponding alerts based on the detected cyberattack. For example, the gateway 12 may transmit a warning message of cyberattack to the terminal electronic device 13 and the device management server 111. Alternatively, the gateway 12 may comprise a speaker and/or an indicator light. An alarm sound coming from the speaker and/or light of the indicator light may be used to notify the user that the gateway 12 is under a cyberattack.

In response to the cyberattack detected by the gateway 12, in some embodiments, the gateway 12 and the terminal electronic device 13 may adopt new valid identification information VI1 and current identification information CI1 respectively at the same time (e.g., a specific time of 0:00 AM of the next day). In response to the cyberattack detected by gateway 12, in some other embodiments, identification information server 112 may generate another identification information set (e.g., identification information set IN2X), and directly (e.g., through the connection IC12) or indirectly (e.g., through the computing device 14) transmit the other set of identification information to the gateway 12. The gateway 12 or the computing device 14 may then transmit the other set of identification information to the terminal electronic device 13. Through this mechanism, the gateway 12 and the terminal electronic device 13 may respond immediately when a cyberattack is detected, so as to increase the connection security of the IoT system 1.

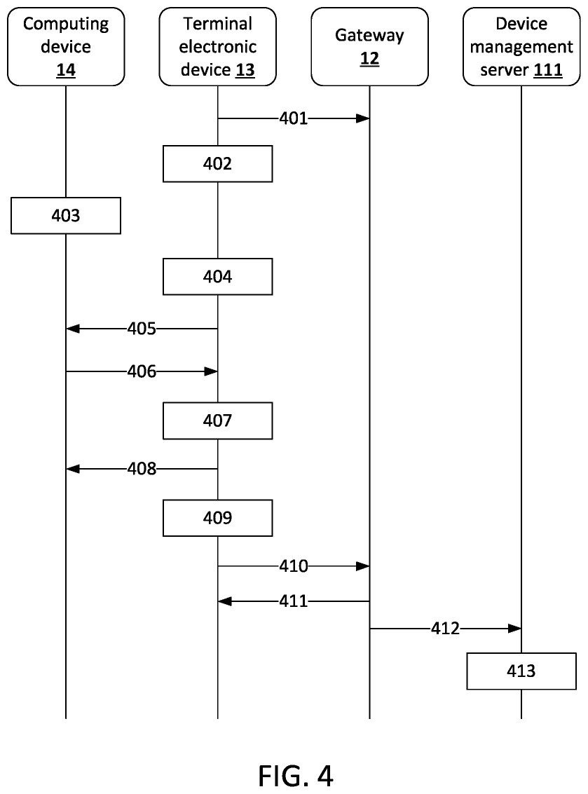

FIG. 4 depicts a schematic view of the IoT system handling connection errors for the terminal electronic device according to one or more embodiments of the present disclosure. The contents shown in FIG. 4 are only for easily illustrating the embodiments, instead of limiting the scope of the present disclosure. Refer to FIG. 4. When the terminal electronic device 13 attempts to establish a connection with the gateway 12 using its stored identification information (i.e., action 401) but fails eventually, the terminal electronic device 13 may issue an exception alert to its user or administrator (i.e., action 402). For example, the terminal electronic device 13 may issue an exception alert by making an alarm sound or lighting up its indication light, or issue in the form of a message through a connection (if any) with the computing device 14. Upon receipt of the exception alert from the terminal electronic device 13, the user or administrator may operate the computing device 14 to initiate a device setting mode (i.e., action 403). Under the circumstance that the exception alert is issued in the form of a message, the computing device 14 may automatically initiate the device setting mode.

After issuing the exception alert, the terminal electronic device 13 may initiate a connection reset procedure (i.e., action 404). In some embodiments, the terminal electronic device 13 may have a physical or virtual reset button, and the connection reset procedure may be activated by the user or administrator via pressing the reset button.

After starting the connection reset procedure, the terminal electronic device 13 may directly establish a connection with the computing device 14 (i.e., action 405). The specific way of establishing the connection between the terminal electronic device 13 and the computing device 14 may be similar to the ways taught by the actions 201-202 and the actions 204-206 as shown in FIG. 2A, and thus similar descriptions will not be repeated here. Subsequently, the computing device 14 may transmit a plurality of pieces of identification information (e.g., the identification information set IN1X or the identification information set IN2X) to the terminal electronic device 13 (i.e., action 406), and the terminal electronic device 13 may perform connection settings accordingly (i.e., action 407), and report back to computing device 14 upon completion (i.e., action 408).

After completing the connection setting based on the plurality of pieces of identification information, the terminal electronic device 13 may be rebooted (i.e., action 409), and attempt to establish a connection with the gateway 12 using the plurality of pieces of identification information (i.e., action 410). When the connection is successfully established, the gateway 12 may reply that the terminal electronic device 13 is connected (i.e., action 411), and may notify the device management server 111 about the joining of the terminal electronic device 13 (i.e., action 412). The device management server 111 may accordingly record the status of the terminal electronic device 13 as “connected” (i.e., action 413).

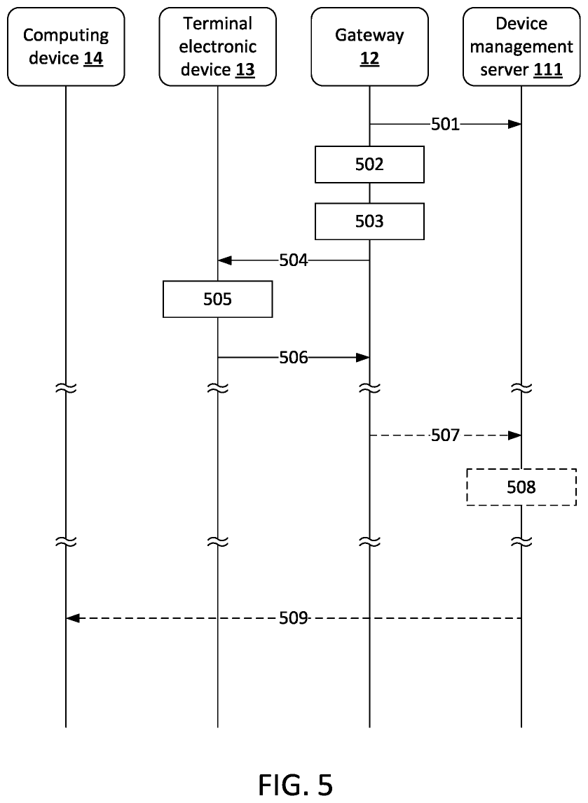

FIG. 5 depicts a schematic view of the IoT system handling connection errors for the gateway according to one or more embodiments of the present disclosure. The contents shown in FIG. 5 are only for easily illustrating the embodiments, instead of limiting the scope of the present disclosure. Refer to FIG. 5. The gateway 12 may attempt to connect to the identification information server 112 multiple times per day (i.e., action 501) to request new identification information from it. However, certain factors may occur in the IoT system 1 to cause the connection between the gateway 12 and the identification information server 112 to fail. Under such circumstances, when the gateway 12 detects that it still fails to establish a connection with the identification information server 112 after a certain period of time (e.g., more than half of the identification information has been tried out) (i.e., action 502), it may randomly generate a plurality of pieces of new identification information, or mutate the existing pieces of identification information (i.e., action 503), and then transmit the pieces of new identification information or the pieces of mutated identification information to the terminal electronic device 13 (i.e., action 504). After receiving the pieces of new identification information, the terminal electronic device 13 may perform connection setting accordingly (i.e., action 505), and report back to the gateway 12 upon completion (i.e., action 506).

If the specific factor causing the failure of the connection between the gateway 12 and the identification information server 112 has been eliminated, and the connection has returned, the gateway 12 may report to the identification information server 112 the plurality of pieces of new identification information that it generated or the mutations it made to the original identification information (i.e., action 507). The identification information server 112 may accordingly update the identification information it records for use by the gateway 12 (i.e., action 508).

When the connection between the gateway 12 and the identification information server 112 has been down for more than a specified period, the identification information server 112 may notify the computing device 14 of such a situation (i.e., action 509).

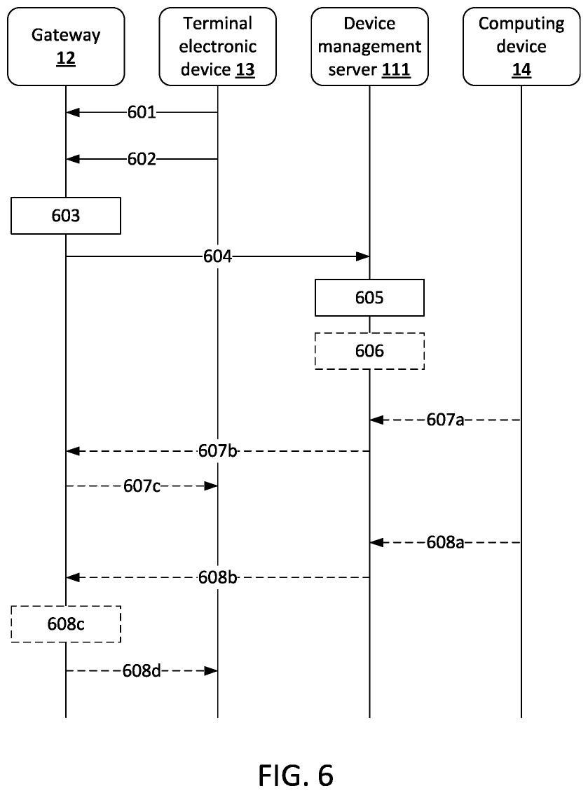

FIG. 6 depicts a schematic view of the terminal electronic device being installed in the wired connection manners in the IoT system according to one or more embodiments of the present disclosure. The contents shown in FIG. 6 are only for easily illustrating the embodiments, instead of limiting the scope of the present disclosure. Refer to FIG. 6. In some other embodiments, the terminal electronic device 13 may attempt to connect to the gateway 12 in the form of a wired connection during the installation phase in its workplace (i.e., action 601). The terminal electronic device 13 may request an IP address from the Dynamic Host Configuration Protocol (DHCP) of the gateway 12 (i.e., action 602).

When a new device (i.e., the terminal electronic device 13) to be connected in a wired manner is found (i.e., action 603), the gateway 12 may notify the device management server 111 (i.e., action 604), and the device management server 111 may then check whether the terminal electronic device 13 is a registered device (i.e., action 605).

When the device management server 111 determines that the terminal electronic device 13 has not been registered, it may associate the terminal electronic device 13 with the gateway 12 in its record and list the terminal electronic device 13 as an unregistered device (i.e., action 606). Different processing will then be performed according to whether the terminal electronic device 13 is a legitimate device.

When determining that the terminal electronic device 13 is a legitimate device, the user or the administrator may notify the device management server 111 through the computing device 14 to redefine the terminal electronic device 13 as a legally registered device (i.e., action 607a), and the device management server 111 may notify the gateway 12 that the terminal electronic device 13 is a legitimate device (i.e., action 607b). After receiving the notification, the gateway 12 may accordingly assign an IP address to the terminal electronic device 13 and allow the connection of the terminal electronic device 13 (i.e., action 607c).

Conversely, actions 608a, 608b, 608c, and 608d may be performed instead of actions 607a, 607b, and 607c. Specifically, when determining that the terminal electronic device 13 is an illegal device, the user or the administrator may notify the device management server 111 via the computing device 14 to list the terminal electronic device 13 as an illegally registered device (i.e., action 608a). The device management server 111 may then notify the gateway 12 that the terminal electronic device 13 is an illegal device (i.e., action 608b). After receiving the notification, the gateway 12 may add the terminal electronic device 13 to a blacklist accordingly (i.e., action 608c), refuse to assign an IP address to it and refuse its connection, and notify the terminal electronic device 13 (i.e., action 608d) of the same.

On the other hand, actions 606 and 607a may be omitted and actions 607b and 607c may be performed directly when the device management server 111 determines that the terminal electronic device 13 is a registered device, since a registered device is, of course, a legitimate device.

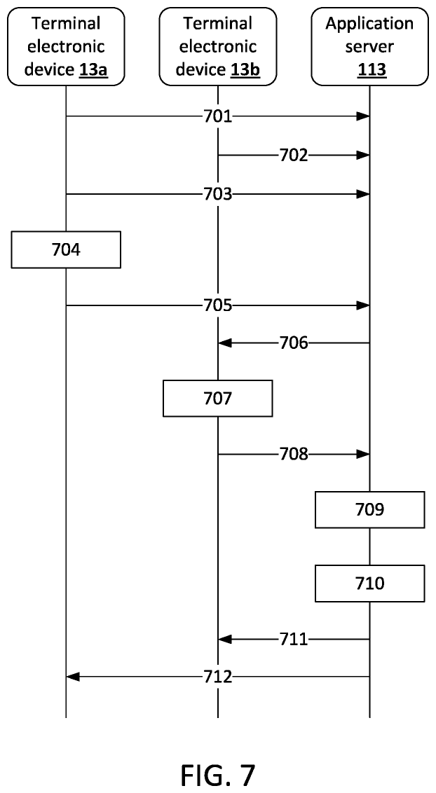

FIG. 7 depicts a schematic view of two devices of the IoT system performing transactions using the identification information as a token according to one or more embodiments of the present disclosure. The contents shown in FIG. 7 are only for easily illustrating the embodiments, instead of limiting the scope of the present disclosure. Refer to FIG. 7. In some embodiments, since each device in the IoT system of the present disclosure will periodically update the identification information, the two devices that have been installed in the IoT system 1 may use the identification information stored therein as tokens for identity authentication and transaction credentials. For convenience of description, it is assumed that there are two installed terminal electronic devices 13a and 13b in the IoT system 1, and the terminal electronic devices 13a and 13b are substantially the same as the terminal electronic devices 13.

First, the terminal electronic device 13a and the terminal electronic device 13b may each be connected to the application server 113 (i.e., action 701 and action 702). The terminal electronic device 13a may notify the application server 113 that it intends to conduct a transaction with the terminal electronic device 13b (i.e., action 703), and may use one of the identification information stored therein as a first token (i.e., action 704, e.g., generated by hashing), and transmit the first token to the application server 113 (i.e., action 705).

After the application server 113 learns the transaction requirements of the terminal electronic device 13a and receives the first token, the application server 113 may request a token from the terminal electronic device 13b accordingly (i.e., action 706). After receiving the notification, the terminal electronic device 13b may use a piece of identification information stored therein as a second token (i.e., action 707) and transmit the second token to the application server 113 (i.e., action 708).

After receiving the first token and the second token, the application server 113 may check the validities of the tokens (i.e., action 709), and permit the terminal electronic device 13a to conduct the transaction with the terminal electronic device 13b after determining that the two tokens are both valid (i.e., action 710), and notifying both parties accordingly (i.e., action 711 and action 712).

The real-world application of the transaction process in which the identification information is used as a token may be, for example, a self-service car wash that is connected to the Internet. In this case, the terminal electronic device 13a may be an electronic device of the user/customer, the terminal electronic device 13b may be a service machine of the self-service car wash, and the application server 113 may be a server for managing the data of the self-service car wash. By using the identification information stored by itself as a token, the service machine may determine whether the user is qualified to use the service (for example, have a membership), and then decide whether to allow the user for accessing the relevant service.

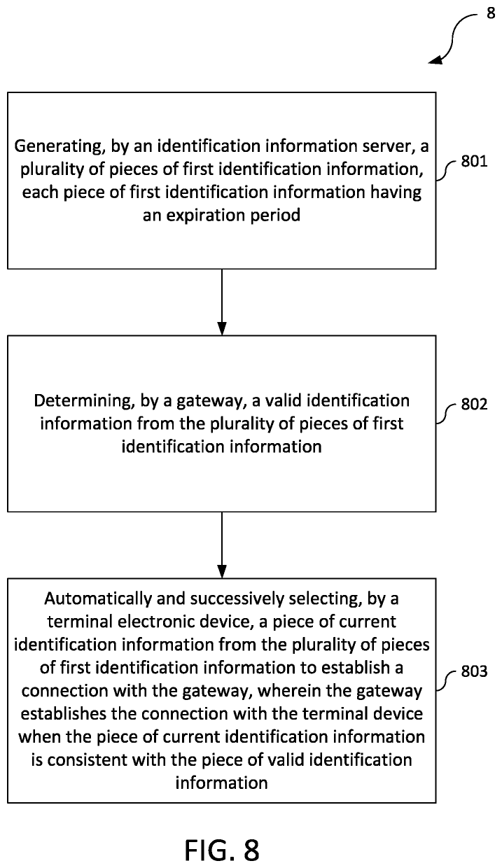

FIG. 8 depicts a connection setting method according to one or more embodiments of the present disclosure. The contents shown in FIG. 8 are only for easily illustrating the embodiments, instead of limiting the scope of the present disclosure. Referring to FIG. 8, a connection setting method 8 for an IoT system (such as but not limited to the above-mentioned IoT system 1) may include steps as follows:
generating, by an identification information server, a plurality of pieces of first identification information, each piece of first identification information having an expiration period (marked as step 801);
determining automatically, by a gateway, a valid identification information from the plurality of pieces of first identification information (marked as step 802); and
automatically and successively selecting, by a terminal electronic device, a piece of current identification information from the plurality of pieces of first identification information to establish a connection with the gateway, wherein the gateway establishes the connection with the terminal electronic device when the piece of current identification information is consistent with the piece of valid identification information (marked as step 803).

In some embodiments, regarding the connection setting method 8, the plurality of pieces of first identification information may have an order, and the gateway may automatically select the valid identification information from the plurality of pieces of first identification information according to the order. Moreover, the terminal electronic device may automatically and successively select a piece of current identification information from the plurality of pieces of first identification information according to the order.

In some embodiments, the connection setting method 8 may further comprise steps as follows:
transmitting, by the gateway, an update request to the identification information server;
generating, by the identification information server, a plurality of pieces of second identification information for replacing the plurality of pieces of first identification information according to the update request;
transmitting, by the identification information server, the plurality of pieces of second identification information to the gateway;
transmitting, by the gateway, the plurality of pieces of second identification information to the terminal electronic device;
automatically determining, by the gateway, a piece of valid identification information from the plurality of pieces of second identification information; and
automatically and successively selecting, by the terminal electronic device, a piece of current identification information from the plurality of pieces of second identification information to establish another connection with the gateway, wherein the gateway establishes the other connection with the terminal electronic device when the piece of current identification information is consistent with the piece of valid identification information. Optionally, the gateway may transmit the update request to the identification information server periodically.

In some embodiments, the connection setting method 8 may further comprise steps as follows:
generating, by the gateway, a plurality of pieces of second identification information for replacing the plurality of pieces of first identification information when the connection between the gateway and the identification information server fails; and
transmitting, by the gateway the plurality of pieces of second identification information transmitted to the terminal electronic device.

In some embodiments, the connection setting method 8 may further comprise a step as follows: reporting, by the gateway, the plurality of pieces of second identification information to the identification information server after the connection between the gateway and the identification information server is restored.

In some embodiments, the connection setting method 8 may further comprise a step as follows: transmitting periodically, by the gateway, a status report to a device management server. The status report may comprise an operating status of the gateway and an operating status of the terminal electronic device.

In some embodiments, the connection setting method 8 may further comprise steps as follows:
detecting, by the gateway, a cyberattack launched by an external device against the gateway; and
issuing, by the gateway, an alert according to the cyberattack detected.

In some embodiments, the connection setting method 8 may further comprise steps as follows:
receiving, by a computing device, the plurality of pieces of first identification information from the identification information server; and
transmitting, by the computing device, the plurality of pieces of first identification information to the gateway and the terminal electronic device.

In some embodiments, the connection setting method 8 may further comprise steps as follows:
receiving, by a computing device, a plurality of pieces of second identification information from the identification information server when the connection between the terminal electronic device and the gateway fails; and
transmitting, by the computing device, the plurality of pieces of second identification information to the terminal electronic device.

In some embodiments, the connection setting method 8 may further comprise a step as follows: registering, by a computing device, the gateway and the terminal electronic device with a device management server.

Each embodiment of the connection setting method 8 basically corresponds to a certain embodiment of the IoT system 1. Therefore, those of ordinary skill in the art may fully understand and implement all the corresponding embodiments of the connection setting method 8 simply by referring to the above descriptions of the IoT system 1, even though not all of the embodiments of the connection setting method 8 are described in detail above.

Although various embodiments are disclosed herein, the invention is not limited to these embodiments. Equivalent objects or methods of the above-described embodiments (e.g., modifications and/or combinations of the above-described embodiments) are also part of the invention without departing from the spirit and scope of the present disclosure. The protection scope of the present invention is subject to the content defined by the following claims as appended.

What is claimed is:

1. An Internet-of-Things (IoT) system, comprising:
an identification information server, configured to generate a plurality of pieces of first identification information, wherein each piece of first identification information has an expiration period;
an application server;
a gateway connected with the identification information server and the application server and storing the plurality of pieces of first identification information, the gateway being configured to automatically determine a piece of valid identification information from the plurality of pieces of first identification information; and
a terminal electronic device storing the plurality of pieces of first identification information, the terminal electronic device being configured to automatically and successively select a piece of current identification information from the plurality of pieces of first identification information to establish a connection with the gateway, wherein when the piece of current identification information is consistent with the piece of valid identification information, the gateway establishes the connection with the terminal electronic device.

2. The IoT system of claim 1, wherein:
the plurality of pieces of first identification information have an order;
the gateway automatically selects the piece of valid identification information from the plurality of pieces of first identification information according to the order, and
the terminal electronic device automatically and successively selects a piece of current identification information from the plurality of pieces of first identification information according to the order.

3. The IoT system of claim 1, wherein:
the gateway is further configured to transmit an update request to the identification information server;
the identification information server is further configured to generate a plurality of pieces of second identification information for replacing the plurality of pieces of first identification information according to the update request, and transmit the plurality of pieces of second identification information to the gateway;
the gateway is further configured to:
transmit the plurality of pieces of second identification information to the terminal electronic device; and
automatically determine a piece of valid identification information from the plurality of pieces of second identification information; and
the terminal electronic device is further configured to:
automatically and successively selecting a piece of current identification information from the plurality of pieces of second identification information to establish another connection with the gateway, wherein the gateway establishes the other connection with the terminal electronic device when the piece of current identification information is consistent with the piece of valid identification information.

4. The IoT system of claim 3, wherein the gateway transmits the update request to the identification information server periodically.

5. The IoT system of claim 1, wherein when a connection between the gateway and the identification information server fails, the gateway is further configured to generate a plurality of pieces of second identification information for replacing the plurality of pieces of first identification information and transmit the plurality of pieces of second identification information to the terminal electronic device.

6. The IoT system of claim 5, wherein the gateway is further configured to report the plurality of pieces of second identification information to the identification information server after the connection between the gateway and the identification information server is restored.

7. The IoT system of claim 1, further comprising a device management server, wherein the gateway is further configured to periodically transmit a status report to the device management server, and the status report comprises an operating status of the gateway and an operating status of the terminal electronic device.

8. The IoT system of claim 1, wherein the gateway is further configured to detect a cyberattack launched by an external device against the gateway and issue an alert according to the detected cyberattack.

9. The IoT system of claim 1, further comprising a computing device configured to receive the plurality of pieces of first identification information from the identification information server and transmit the plurality of pieces of first identification information to the gateway and the terminal electronic device.

10. The IoT system of claim 1, further comprising a computing device configured to receive a plurality of pieces of second identification information from the identification information server and transmit the plurality of pieces of second identification information to the terminal electronic device when the connection between the terminal electronic device and the gateway fails.

11. The IoT system of claim 1, further comprising a computing device and a device management server, wherein the computing device is configured to register the gateway and the terminal electronic device with the device management server.

12. The IoT system of claim 11, wherein the device management server, the identification information server and the application server are integrated into one single server.

13. A connection setting method for an Internet of Things (IoT) system, comprising steps as follows:
generating, by an identification information server, a plurality of pieces of first identification information, each piece of first identification information having an expiration period;
determining automatically, by a gateway, a valid identification information from the plurality of pieces of first identification information; and
automatically and successively selecting, by a terminal electronic device, a piece of current identification information from the plurality of pieces of first identification information to establish a connection with the gateway, wherein the gateway establishes the connection with the terminal electronic device when the piece of current identification information is consistent with the piece of valid identification information.

14. The connection setting method of claim 13, wherein:
the plurality of pieces of first identification information have an order;
the gateway automatically selects the valid identification information from the plurality of pieces of first identification information according to the order, and
the terminal electronic device automatically and successively selects a piece of current identification information from the plurality of pieces of first identification information according to the order.

15. The connection setting method of claim 13, further comprising:
transmitting, by the gateway, an update request to the identification information server;
generating, by the identification information server, a plurality of pieces of second identification information for replacing the plurality of pieces of first identification information according to the update request;
transmitting, by the identification information server, the plurality of pieces of second identification information to the gateway;
transmitting, by the gateway, the plurality of pieces of second identification information to the terminal electronic device;
automatically determining, by the gateway, a piece of valid identification information from the plurality of pieces of second identification information; and
automatically and successively selecting, by the terminal electronic device, a piece of current identification information from the plurality of pieces of second identification information to establish another connection with the gateway, wherein the gateway establishes the other connection with the terminal electronic device when the piece of current identification information is consistent with the piece of valid identification information.

16. The connection setting method of claim 15, wherein the gateway transmits the update request to the identification information server periodically.

17. The connection setting method of claim 13, further comprising:
generating, by the gateway, a plurality of pieces of second identification information for replacing the plurality of pieces of first identification information when a connection between the gateway and the identification information server fails; and
transmitting, by the gateway the plurality of pieces of second identification information transmitted to the terminal electronic device.

18. The connection setting method of claim 17, further comprising:
reporting, by the gateway, the plurality of pieces of second identification information to the identification information server after the connection between the gateway and the identification information server is restored.

19. The connection setting method of claim 13, further comprising:
transmitting periodically, by the gateway, a status report to a device management server, wherein the status report comprises an operating status of the gateway and an operating status of the terminal electronic device.

20. The connection setting method of claim 13, further comprising:
detecting, by the gateway, a cyberattack launched by an external device against the gateway; and
issuing, by the gateway, an alert according to the detected cyberattack.

21. The connection setting method of claim 13, further comprising:
receiving, by a computing device, the plurality of pieces of first identification information from the identification information server; and
transmitting, by the computing device, the plurality of pieces of first identification information to the gateway and the terminal electronic device.

22. The connection setting method of claim 13, further comprising:
receiving, by a computing device, a plurality of pieces of second identification information from the identification information server when the connection between the terminal electronic device and the gateway fails; and
transmitting, by the computing device, the plurality of pieces of second identification information to the terminal electronic device.

23. The connection setting method of claim 13, further comprising:
registering, by a computing device, the gateway and the terminal electronic device with a device management server.
